(19) United States
(12) Patent Application Publication
(10) Pub. No.: US 2002/0185971 A1
(43) Pub. Date: Dec. 12, 2002

(54) Discharge lamp with improved starting

(76) Inventor: Ahmed Mokhtari, Paris (FR)

Correspondence Address: Corporate Patent Counsel, U.S. Philips Corporation, 580 White Plains Road, Tarrytown, NY, 10591, US

(21) Appl. No.: 10/061,178

(22) Filed: Feb. 1, 2002

(30) Foreign Application Priority Data
Feb. 5, 2001 (FR) 0101529

(51) Int. Cl. H01J 11/00; H01J 61/00

(52) U.S. Cl. 313/567

(57) ABSTRACT

The present invention relates to a discharge lamp containing a radioactive gas for starting said lamp. The radioactive gas is enclosed in a capsule, a wall of which is transparent to the radioactive radiation. Thus, the capsule promotes the starting of the discharge lamp, whilst preventing consumption of the radioactive gas which it contains, since the latter is isolated from the filling gas by the sealed walls of the capsule. The service life of the discharge lamp is thus increased.

The present invention relates to a discharge lamp containing a radioactive gas for starting said lamp.

The invention also relates to a starter of the glow type, which contains a radioactive gas and is used for starting a discharge lamp.

The present invention is applied, for example, in neon lamps or in miniature fluorescent lamps of the cold electrode type, which are designed for the car industry, or for signaling, the reliability of the starting being essential for these lamps.

U.S. Pat. No. 2,930,872 describes a starter of the glow type, which is used for starting elongated discharge lamps of the low-pressure type, such as fluorescent lamps. Said patent proposes a starter with operating characteristics which are stable over a period of time. For this purpose, the starter of the prior art glow type comprises an envelope, which, in addition to a filling gas, contains a minute quantity of radioactive krypton, in order to provide a source of ionization, which makes it possible to eliminate the effect of darkness. In addition, said lamp contains a small proportion of gaseous impurities.

It is an object of the present invention to provide a discharge lamp which has a longer service life.

In fact, if the addition of radioactive krypton to the filling gas contained in a starter of the glow type for a discharge lamp, or inside a discharge lamp itself, initially improves the starting of said lamp, this addition subsequently gives rise to consumption of the radioactive krypton over a period of time. This disadvantage is caused by the migration of the electrons towards the negative electrode, which phenomenon is known by the name of cataphoresis, which, combined with the sputtering of the electrodes, gives rise to progressive disappearance of the radioactive krypton. This point is all the more critical for discharge lamps of the elongated tubular type, which are supplied by a direct current. Consequently, the radioactive krypton tends to be rarefied, and no longer permits starting of the lamp after a few hundred hours, which consequently limits the service life of said lamp.

In order to eliminate these disadvantages, the discharge lamp according to the present invention is distinguished in that the radioactive gas which it contains is enclosed in a capsule, a wall of which is transparent to the radioactive radiation.

Said capsule with a wall which is transparent to the radioactive radiation will promote the starting of the discharge lamp, by ionization of the filling gas, while preventing a consumption of the radioactive gas which it contains, since the latter is isolated from the filling gas by the sealed walls of the capsule. The service life of the discharge lamp is thus increased.

Additionally, the use of a capsule of this type also has a significant advantage in terms of protection of the environment. In fact, the capsule can easily be recycled, or better still reused, which considerably limits the damage caused to the environment by discharge lamps of this type.

In addition, in the case of a lamp which is supplied with a direct current, the discharge requires free electrons in the vicinity of the anode, for the initial starting.

This is the reason why the discharge lamp according to the present invention is distinguished in that the capsule is positioned sufficiently close to an anode of the discharge lamp to facilitate the starting of the lamp, when said lamp is supplied with a direct current.

The present invention also relates to a starter of the glow type, which is designed for starting a discharge lamp, said starter being characterized in that the radioactive gas which it contains is enclosed in a capsule, a wall of which is transparent to the radioactive radiation.

These and other aspects of the invention are apparent from and will be elucidated, by way of non-limiting example, with reference to the embodiments(s) described hereinafter.

In the drawings:

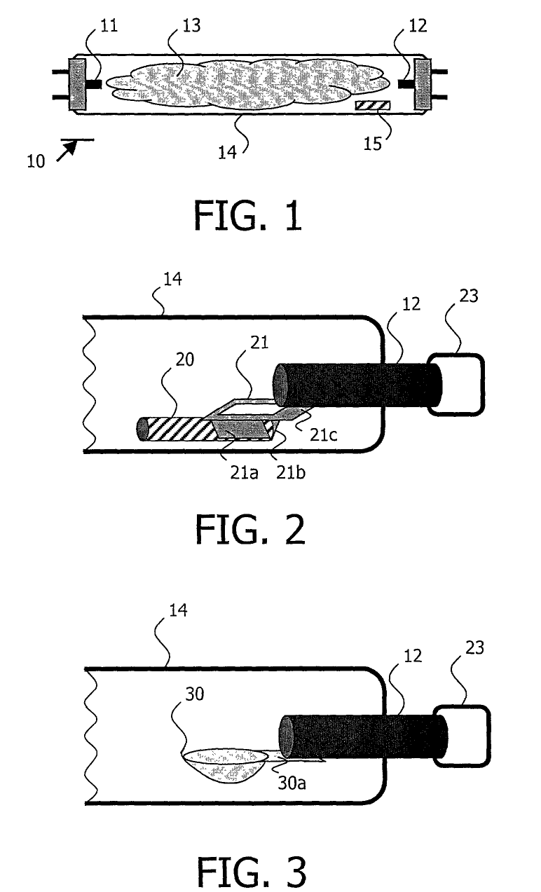

FIG. 1 shows highly schematically a discharge lamp according to the invention;

FIG. 2 shows part of a discharge lamp comprising a radioactive gas capsule, according to a first embodiment of the invention;

FIG. 3 shows part of a discharge lamp comprising a radioactive gas capsule, according to a second embodiment of the invention;

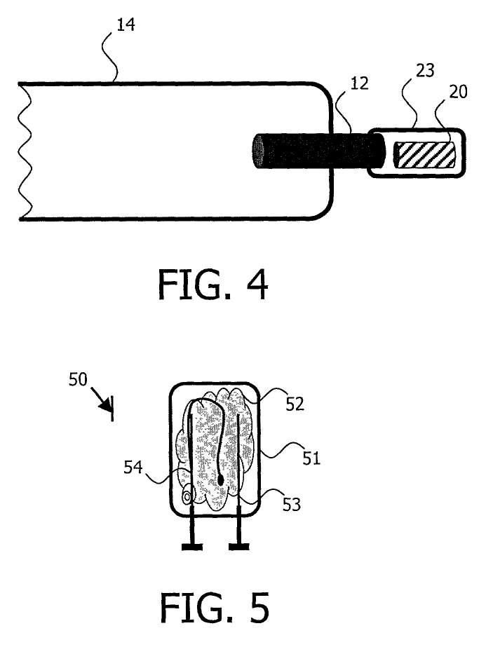

FIG. 4 shows part of a discharge lamp comprising a radioactive gas capsule, according to a third embodiment of the invention; and

FIG. 5 illustrates a starter of the glow type according to the invention, comprising a radioactive gas capsule.

The present invention relates to a discharge lamp which is designed for the car industry or for signaling. This discharge lamp can be either a neon lamp, or a miniature fluorescent lamp with cold electrodes.

FIG. 1 is a schematic representation of a discharge lamp according to the invention. A discharge lamp 10 of this type comprises mainly:

a first electrode 11, which is, for example, the direct current negative electrode or the cathode;

a second electrode 12, which is, for example, the direct current positive electrode or the anode;

a filling gas 13, for example, neon or argon, which is lit at low pressure under the effect of an electric voltage between the two electrodes; and

a glass peripheral wall 14, which is covered with a fluorescent coating in the case of a fluorescent lamp.

The discharge lamp additionally comprises a capsule 15, containing a radioactive gas, a wall of said capsule being transparent to the radioactive radiation in order to facilitate starting of the discharge lamp by ionization of the filling gas, while consumption of the radioactive gas which the lamp contains is prevented. In the preferred embodiment, the radioactive gas is radioactive krypton ₃₆Kr⁸⁵, but it will be apparent to persons skilled in the art that any other radioactive gas can be suitable for this application.

In addition, if the discharge lamp is supplied with a direct current, the capsule of radioactive krypton ₃₆Kr⁸⁵ is preferably placed at the level of the anode. In fact, in this case, the discharge requires free electrons in the vicinity of the anode, for the initial starting. This is confirmed by the following experiences:

a light source placed in the immediate vicinity of the anode of the discharge lamp promotes the starting of the latter; and

the same light source placed at the level of the cathode does not promote the starting of the lamp.

In the preferred embodiment, the wall which is transparent to the radioactive radiation of the capsule is made of glass with a thickness of 0.5 mm. A capsule of this type is not completely transparent to the radioactive radiation, since it absorbs part of the radiation, but nevertheless it remains efficient.

Other materials, such as iron, aluminum, nickel or steel, to mention only them, can advantageously be used to produce the capsules. It is the thickness of the selected material that makes it transparent to the radioactive radiation. The radioactive krypton ₃₆Kr⁸⁵ emits in essence (approximately 99% of the radiation) Beta radiation, with energy of 0.67 Mev. For example, in order to absorb the Beta radiation of 0.67 Mev:

a thickness of iron of approximately 30 μm is necessary;

a thickness of aluminum of approximately 80 μm is necessary; and

a thickness of glass of approximately 100 μm is necessary.

The radioactive krypton also emits approximately 1% gamma radiation with energy of 0.52 Mev. This radiation is more penetrating, with the result that a thickness of approximately a centimeter makes the gamma radiation decrease by half. Consequently, the thickness of the capsule is preferably less than the values previously given with reference to the Beta radiation, for the various materials envisaged to permit the starting of the discharge lamp. However, higher values, of approximately a millimeter for the glass, for example, can also be suitable, provided that the transmitted gamma radiation has sufficiently high energy to assist the starting.

In the preferred embodiment, the capsule has a tubular shape with a diameter from 1 to 2 mm, and a length from 5 to 10 mm, depending on the type of discharge lamp. The volume of radioactive krypton ₃₆Kr⁸⁵ is then 4 to 30 mm³ at less than one bar, its filling pressure varying from 0.75 to 1 bar. Since the radioactivity of the krypton ₃₆Kr⁸⁵ is 100 million Becquerels per liter, the radioactivity of the capsule is 330 Becquerels at the most. In addition to the fact that the capsule can be recycled or reused, the discharge lamp which contains it constitutes potentially less danger to the environment than a neon tube produced at present, which contains radioactive materials with radioactivity of approximately 800 Becquerels.

FIG. 2 shows the contents of a discharge lamp according to the invention, the lamp comprising a radioactive gas capsule of a tubular type, which is fastened to an electrode according to a first fastening method. Said capsule 20 is made of glass, and is held by a thin metal strip 21 formed by two fastening fins 21a, 21b, which grip the capsule, and a main part 21c, which is soldered onto an electrode, which is the direct current anode 12. A main glass tube 14 is sealed around the electrode. A second glass tube, which is known as the closed pumping tube 23, is also shown in this Figure. This tube makes is possible to discharge from the lamp the air it contains, then to fill it with the filling gas required, by means of the anode 12, which is hollow.

FIG. 3 shows the contents of a discharge lamp according to the invention, the lamp comprising a radioactive gas capsule in the form of a closed dish, which is fastened to an electrode according to another fastening method. In this case, said capsule 30 is made of metal, and is soldered to an electrode, which in this case is the anode 12, by means of a small metal plate 30a.

FIG. 4 shows the contents of a discharge lamp according to the invention, the lamp comprising a radioactive gas capsule of a tubular type. In this case, the capsule 20 is inside the closed pumping tube 23, the dimensions of which are designed to limit displacements of the capsule which it contains.

FIG. 5 shows a starter of the glow type 50 according to the invention, comprising a radioactive gas capsule. Said starter comprises a bulb 51 which is filled with a rare gas 52, as well as two electrodes 53, 54, at least one of which is a bimetal plate 54. This plate, which consists of two metals with different coefficients of expansion, has the property of bending under the influence of heat. When a voltage is applied to the starter, a light discharge occurs in the rare gas, and the heat which is released by the cathodic drop makes the plate bend, to that the contacts are established and the electrodes of the discharge lamp to which the starter is connected heat up. At this moment, the starter is short-circuited, which makes the discharge stop, and causes the bimetal plate to cool down and the contacts to reopen. The voltage pulse which is derived from the current cut-off then starts the discharge lamp.

The preceding description provided with reference to FIGS. 1 to 5 illustrates the invention, rather than limiting it. It will be appreciated that other forms of capsules are possible, associated with other fastening means for holding them.

No reference sign in brackets in a claim may be interpreted in a limiting manner. The verb “comprise” and its conjugations does not exclude the presence of other elements listed in a claim. The word “one” before an element does not exclude the presence of a plurality of these elements.

1. A discharge lamp (10) containing a radioactive gas for starting said lamp, characterized in that the radioactive gas is enclosed in a capsule, a wall of which is transparent to the radioactive radiation.

2. A discharge lamp (10) as claimed in claim 1, characterized in that the capsule is positioned sufficiently close to an anode of the discharge lamp to facilitate the starting of the lamp, when said lamp is supplied with a direct current.

3. A discharge lamp (10) as claimed in claim 1 or 2, characterized in that the capsule (20) is made of glass and in that the discharge lamp comprises a metal strip (21), which is soldered onto an electrode (12) and adapted to grip the capsule.

4. A discharge lamp (10) as claimed in claim 1 or 2, characterized in that the capsule (30) is made of metal and is soldered onto an electrode (12).

5. A discharge lamp (10) as claimed in claim 1 or 2, characterized in that the capsule is embedded into the closed pumping tube (23).

6. A starter of the glow type, which is designed for starting a discharge lamp, said starter containing a radioactive gas, and being characterized in that the radioactive gas which it contains is enclosed in a capsule, a wall of which is transparent to the radioactive radiation.
